(19) United States
(12) Patent Application Publication
(10) Pub. No.: US 2015/0213964 A1
(43) Pub. Date: Jul. 30, 2015

(54) ELECTROLYTE FOR DYE-SENSITIZED SOLAR CELL AND DYE-SENSITIZED SOLAR CELL INCLUDING THE SAME

(71) Applicant: Electronics and Telecommunications Research Institute, Daejeon (KR)

(72) Inventors: Jeumjong KIM, Daejeon (KR); Moo Jung CHU, Daejeon (KR); Ju Mi KIM, Daejeon (KR)

(73) Assignee: Electronics and Telecommunications Research Institute, Daejeon (KR)

(21) Appl. No.: 14/340,715

(22) Filed: Jul. 25, 2014

(30) Foreign Application Priority Data
Jan. 28, 2014 (KR) 10-2014-0010601

(51) Int. Cl. H01G 9/20

(52) U.S. Cl. CPC H01G 9/2018; H01G 9/2031; H01G 9/2022; H01G 9/2059

(57) ABSTRACT

Provided are an electrolyte for a dye-sensitized solar cell and a dye-sensitized solar cell including the same. The electrolyte for a dye-sensitized solar cell includes an organic solvent, a metal anion compound, and a quaternary ammonium salt compound (R₄N⁺X⁻). X⁻ and Y⁻ are multi-redox systems which are in chemical equilibrium.

### CROSS-REFERENCE TO RELATED APPLICATIONS

This U.S. non-provisional patent application claims priority under 35 U.S.C. §119 of Korean Patent Application No. 10-2014-0010601, filed on Jan. 28, 2014, the entire contents of which are hereby incorporated by reference.

### BACKGROUND OF THE INVENTION

Recently, the importance of development of next generation clean energy is increasing due to serious environmental pollution and the exhaustion of fossil energy. Among others, since a solar cell is a device that directly converts the energy of sunlight into electric energy and pollutes less, and has a limitless resource and a semi-permanent lifespan, it is expected as an energy source capable of solving future energy problems. A solar cell indicates a cell which allows current to flow using the photovoltaic effect in which an inner semiconductor absorbs light to create electrons and holes. Existing solar cells mainly employ a semiconductor device in the form of a diode by forming a p-n junction in an inorganic semiconductor, such as gallium arsenide (GaAs). While the above-described inorganic semiconductor has high energy conversion efficiency, it has not sufficiently been used in the field of solar cells due to high production costs. To overcome the limitations of the above-described inorganic semiconductors, a technique of replacing the inorganic semiconductor with a dye has been proposed.

Since a dye absorbs light in the visible light band, the dye has an inherent color. A solar cell using such a dye generates electricity through a so-called oxidation-reduction reaction (redox) in which when the dye absorbs light, electrons and holes are separated and then again bonded. Such a solar cell is called a dye-sensitized solar cell.

After a dye-sensitized nanoparticle titanium oxide solar cell was developed by Gratzel et al. at the Ecole Polytechnique Fedrale de Lausanne (EPFL) in 1991, many studies on this field have been conducted. Unlike the existing silicon solar cells, a dye-sensitized solar cell is a photoelectrochemical solar cell which includes a dye molecule capable of absorbing visible ray to generate electron-hole pairs, and a transition metal oxide transferring the generated electrons as main materials.

A representative example of dye-sensitized solar cells known to date is a dye-sensitized solar cell disclosed by Gratzel et al. in Switzerland. Dye-sensitized solar cells of Gratzel et al. generally include a semiconductor electrode formed of nanoparticle titanium dioxide (TiO₂) coated with dye molecules, a platinum electrode, and an electrolyte filled therebetween. These dye-sensitized solar cells have come to prominence in that they are may be fabricated at lower costs per power than silicon solar cells. Also, compared with the existing silicon solar cells, since the dye-sensitized solar cells have excellent transparency, they have advantages that may be applied to various fields, such as BIPV or greenhouse to cultivate plants. However, the electrolyte used in the existing dye-sensitized solar cells includes iodide ions, such as I⁻/I₃⁻, and thus has a limitation in that the corrosiveness of iodide damages the stability of the cells. The electrolyte, which was developed to solve the limitation regarding the stability of the cells, is a Co²⁺/Co³⁺ redox couple. However, the Co²⁺/Co³⁺ redox couple has a very low mobility in a cobalt compound and a very low efficiency in a Ruthenium dye widely used due to low mobility. Therefore, the Co²⁺/Co³⁺ redox couple is limitedly usable only in a specific organic dye. Owing to such limitations, it is strongly required to develop a new electrolyte capable of enhancing the stability and the efficiency together.

### SUMMARY OF THE INVENTION

The present invention disclosed herein relates to an electrolyte, and more particularly, to an electrolyte for a dye-sensitized solar cell, and a dye-sensitized solar cell including the same.

The present invention provides an electrolyte for a dye-sensitized solar cell having high stability and enhanced efficiency.

The present invention also provides a dye-sensitized solar cell including the electrolyte.

The objects of the present invention are not limited to the foregoing those, and other objects will be clearly understood to those skilled in the art from the following description.

Embodiments of the present invention provide electrolytes for dye-sensitized solar cells. The electrolytes for a dye-sensitized solar cell include an organic solvent, a metal anion compound (M(Y⁻)ₙ), and a quaternary ammonium salt compound (R₄N⁺X⁻), where X⁻ and Y⁻ are multi-redox systems which are in chemical equilibrium.

In some embodiments, the multi-redox systems may include (X⁻, Y⁻)/(X₃⁻, X₂Y⁻, Y⁻₂X⁻, Y⁻₃).

In other embodiments, X⁻ may include a halogen anion, an alkyl anion, an alkyloxy anion, an acetoxy anion or an alkylthiol anion, and Y⁻ may include an alkyl anion, an alkyloxy anion, an acetoxy anion, a phenyl anion, a phenyloxy anion, or an alkylthiol anion.

In still other embodiments, M may include Pb, Pd, Zn, Sn, Co, Li or Cu.

In even other embodiments, the quaternary ammonium salt compound may include at least one selected from the group consisting of hexyldimethylimidazolium iodide (HDMII), ethyltrimethylindolium iodide (ETMII), and tetrabutylammonium iodide (Bu₄N⁺I⁻).

In yet other embodiments, the organic solvent may include at least one selected from the group consisting of acetonitrile, valeronitrile, methanol, ethanol, propanol, butanol, ethyl ether, acetone, dimethylcarbonate, 3-methoxypropionitrile, tetrahydrofuran, dichloromethane, dichloroethane, and chloroform.

In further embodiments, the electrolytes for a dye-sensitized solar cell may further include an additive that may include guanidine thiocyanate and t-butylpyridine.

In still further, the metal anion compound (M(Y⁻)ₙ) may be 0.05 M based on the organic solvent, the quaternary ammonium salt compound (R₄N⁺X⁻) may be 0.05 M to 0.6 M based on the organic solvent, the t-butylpyridine may be 0.5 M based on the organic solvent, and the guanidine thiocyanate may be 0.1 M based on the organic solvent.

In other embodiments of the present invention, dye-sensitized solar cells include a first electrode formed on a first substrate, a second electrode formed on a second substrate and facing the first electrode, and an electrolyte including an organic solvent, a metal anion compound (M(Y⁻)ₙ), and a quaternary ammonium salt compound (R₄N⁺X⁻), where X⁻ and Y⁻ are multi-redox systems which are in chemical equilibrium.

In some embodiments, the first electrode may include a nanoparticle metal oxide layer which is formed on the first substrate facing the second electrode and to which a dye is adsorbed.

In other embodiments, the second electrode may include a platinum layer formed on the second substrate facing the first electrode.

In still other embodiments, X⁻ may include a halogen anion, an alkyl anion, an alkyloxy anion, an acetoxy anion or an alkylthiol anion, Y⁻ may include an alkyl anion, an alkyloxy anion, an acetoxy anion, a phenyl anion, a phenyloxy anion, or an alkylthiol anion, and M may include Pb, Pd, Zn, Sn, Co, Li or Cu.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a cross-sectional view for explaining a dye-sensitized solar cell according to an embodiment of the present invention;

FIGS. 2 through 5 are cross-sectional views for explaining a method of fabricating a dye-sensitized solar cell according to an embodiment of the present invention; and

FIG. 6 is a current-voltage graph showing measurement results of photovoltage and photocurrent in dye-sensitized solar cells according to Examples 1, and 4 to 6 of the present invention, and Comparative Example.

### DETAILED DESCRIPTION OF PREFERRED EMBODIMENTS

The above-described objects, other objects, features and advantages of the present invention will be easily understood from the detailed description of exemplary embodiments of the present invention below by referring to the accompanying drawings. The invention may, however, be embodied in different forms and should not be construed as limited to the embodiments set forth herein. Rather, these embodiments are provided so that this disclosure will be thorough and complete, and will fully convey the scope of the present invention to those skilled in the art.

It will also be understood that when an element is referred to as being ‘on’ another element, it can be directly on the other element, or a third element may also be present. In the figures, the dimensions of elements are exaggerated for clarity of illustration.

Additionally, the embodiment in the detailed description will be described with sectional views as ideal exemplary views of the present invention. In the figures, the dimensions of layers and regions are exaggerated for clarity of illustration. Accordingly, shapes of the exemplary views may be modified according to manufacturing techniques and/or allowable errors. Therefore, the embodiments of the present invention are not limited to the specific shape illustrated in the exemplary views, but may include other shapes that may be created according to manufacturing processes. For example, an etched region illustrated as a rectangle may have rounded or curved features. Areas exemplified in the drawings have general properties, and are used to illustrate a specific shape of a semiconductor package region. Thus, this should not be constructed as limited to the scope of the present invention. While such terms as ‘first’, ‘second’, and the like may be used herein to describe various elements, such elements should not be limited to the above terms. These terms are only used to distinguish one element from another element. Embodiments described and exemplified herein include complementary embodiments thereof.

In the following description, the technical terms are used only for explaining exemplary embodiments while not limiting the present invention. The terms of a singular form may include plural forms unless otherwise specified. The meaning of “include,” “comprise,” “including,” or “comprising,” does not exclude other properties, regions, fixed numbers, steps, processes, elements and/or components.

Hereinafter, exemplary embodiments will be described in detail with reference to the accompanying drawings.

The electrolyte according to an embodiment of the present invention may include an organic solvent, a metal anion compound (M(Y⁻)ₙ), and a quaternary ammonium salt compound (R₄N⁺X⁻).

The organic solvent may include at least one selected from the group consisting of acetonitrile, valeronitrile, alcohols, such as methanol, ethanol, propanol and butanol, ethyl ether, acetone, dimethylcarbonate, 3-methoxypropionitrile, tetrahydrofuran, dichloromethane, dichloroethane, and chloroform. In the present invention, the organic solvent is not limited thereto.

According to an embodiment of the present invention, in the metal anion compound (M(Y⁻)ₙ) and the quaternary ammonium salt compound (R₄N⁺X⁻), X⁻ and Y⁻ are multi-redox systems which are in chemical equilibrium. According to an aspect, the multi-redox systems may include (X⁻, Y⁻)/(X₃⁻, X₂Y⁻, Y⁻₂X⁻, Y⁻₃). In more detail, X⁻ and Y⁻ exist simultaneously in the electrolyte and allow at least four redox reactions to take place while generating multi-ions, such as X₃⁻, X₂Y⁻, Y⁻₂X⁻, Y⁻₃.

X⁻ may include a halogen anion, such as I⁻ or Br⁻, an alkyl anion, an alkyloxy anion, an acetoxy anion, or an alkylthiol anion, but is not limited thereto. Y⁻ may include an alkyl anion, an alkyloxy anion, an acetoxy anion, a phenyl anion, a phenyloxy anion or an alkylthiol anion, but is not limited thereto. According to an aspect of the present invention, Y⁻ may not include a halogen anion.

In such a dye-sensitized solar cell, when the dye absorbs light, is excited, and is oxidized, the dye should be immediately regenerated to its original state, and a redox mediator existing in the electrolyte immediately reduces the oxidized dye sensitizer and then becomes an oxidized state. After the oxidized mediator is transferred to a counter electrode through diffusion, the oxidized mediator may be reduced by electrons transferred from the counter electrode. The redox couple included in the electrolyte plays a great role in determining the opening voltage of the solar cell as well as promoting the regeneration of the dye. In detail, the open voltage of the dye-sensitized solar cell is determined by a difference between a Fermi level of a photoelectrode corresponding to an electron energy level of an electrode, and a Fermi level of the electrolyte, and the Fermi level of the electrolyte may be equal to a redox potential (E) of the redox couple. When the dye-sensitized solar cell includes a redox couple (X⁻, Y⁻)/(X₃⁻, X₂Y⁻, Y⁻₂X⁻, Y⁻₃) including new anions as well as iodide ions, the redox potential may be electrochemically changed toward a more positive direction, and thus the open voltage of the dye-sensitized solar cell may be adjusted through the multi-redox systems including (X⁻, Y⁻)/(X₃⁻, X₂Y⁻, Y⁻₂X⁻, Y⁻₃).

In the metal anion compound (M(Y⁻)ₙ), M may include, but is limited to, include metals, such as Pb, Pd, Zn, Sn, Co, Li, and Cu.

The quaternary ammonium salt compound (R₄N⁺X⁻) may include, but is limited to, a halogen anion or imidazole, pyridine, indole, triazole, tetrazole and the like that may form salts with anions other than a halogen ion.

For example, the quaternary ammonium salt compound (R₄N⁺X⁻) may include at least one selected from the group consisting of hexyldimethylimidazolium iodide (HDMII), ethyltrimethylindolium iodide (ETMII), and tetrabutylammonium iodide (Bu₄N⁺I⁻).

The hexyldimethylimidazolium iodide (HDMII) is expressed by Formula 1 below.

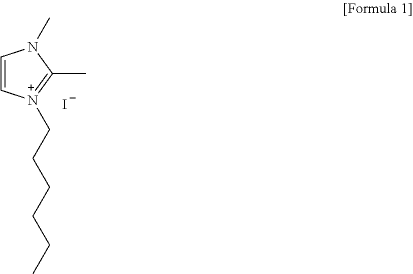

The ethyltrimethylindolium iodide (ETMII) is expressed by Formula 2 below.

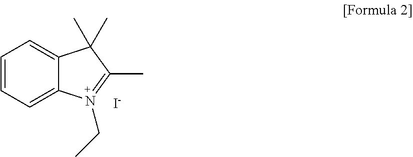

As described above, since the electrolytes for dye-sensitized solar cells according to embodiments of the present invention does not include iodide having high corrosiveness but include the quaternary ammonium salt compound and the metal anion compound, the electrolytes may improve the stability of the solar cells. Also, it is possible to adjust the open voltage of dye-sensitized solar cells through multi-redox systems including (X⁻, Y⁻)/(X₃⁻, X₂Y⁻, Y⁻₂X⁻, Y⁻₃).

According to an embodiment of the present invention, the electrolytes for dye-sensitized solar cells may further include an additive. The additive may include guanidine thiocyanate and t-butylpyridine.

According to an aspect of the present invention, the metal anion compound (M(Y⁻)ₙ) may be 0.05 M based on the organic solvent, the quaternary ammonium salt compound (R₄N⁺X⁻) may be 0.05 M to 0.6 M based on the organic solvent, the t-butylpyridine may be 0.5 M based on the organic solvent, and the guanidine thiocyanate may be 0.1 M based on the organic solvent.

Hereinafter, a dye-sensitized solar cell according to an embodiment of the present invention will be described.

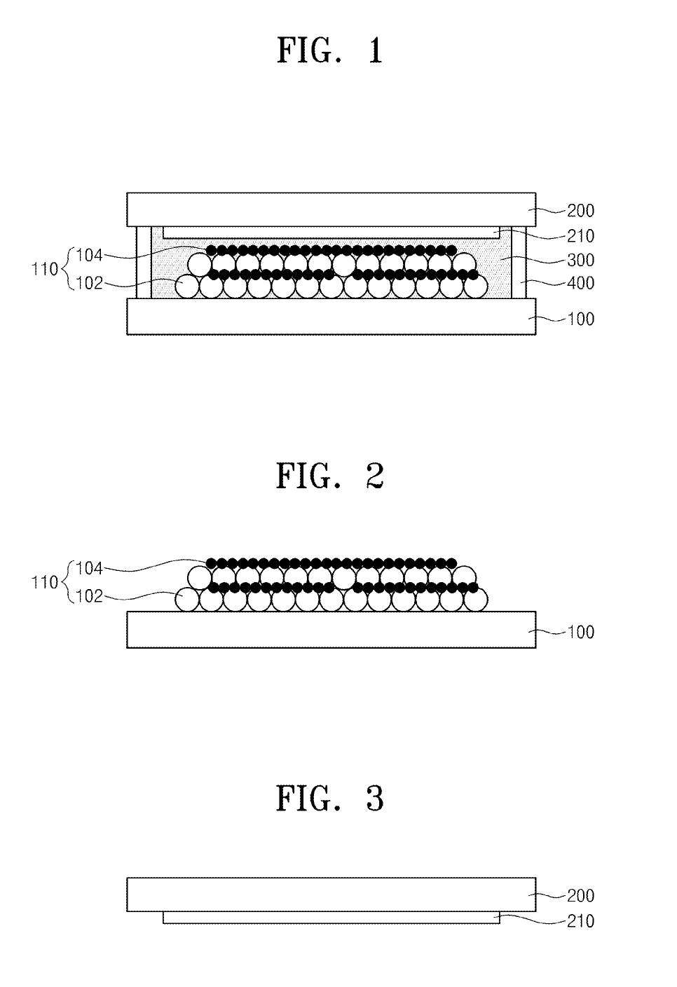

FIG. 1 is a cross-sectional view for explaining a dye-sensitized solar cell according to an embodiment of the present invention.

Referring to FIG. 1, the dye-sensitized solar cell may include first and second substrates 100 and 200 facing each other and spaced apart from each other, and an electrolyte 300 filled between the first and second substrates 100 and 200.

The first substrate 100 may include a conductive glass. For example, the first substrate 100 may be a glass substrate on which indium tin oxide (ITO) or fluorine-doped tin oxide is coated. Although not shown in detail, according to another aspect of the present invention, a TiCl₄ layer may be further disposed between the first substrate 100 and a semiconductor electrode.

A first electrode 110 may be formed at a thickness of about 5 μm to about 15 μm on the first substrate 100 facing the second substrate 200. The first electrode 110 may include a nanoparticle metal oxide 102. The nanoparticle metal oxide 102 may include, for example, titanium dioxide (TiO₂), tin dioxide (SnO₂), or zinc oxide (ZnO). The nanoparticle metal oxide 102 may have a particle diameter in a range of about 5 nm to about 30 nm.

The first electrode 110 may include a dye 104 adsorbed to the nanoparticle metal oxide 102. The dye 104 may include an organic metal compound and an organic compound.

The second substrate 200 may include a conductive glass. The second substrate 200 may be, for example, a glass substrate coated with ITO or FTO.

A second electrode 210 may be formed on the second substrate 200 facing the first substrate 100. The second electrode 210 may include a metal, such as platinum (Pt). As shown in FIG. 1, the first and second electrodes 110 and 210 may face each other.

The electrolyte 300 may fill a space between the first and second electrodes 110 and 210. The electrolyte 300 may include an organic solvent, a metal anion compound (M(Y⁻)ₙ), and a quaternary ammonium salt compound (R₄N⁺X⁻). Since the detailed description of the electrolyte 300 is substantially the same as that described above, it will be omitted.

The dye-sensitized solar cell may further include barrier ribs 400. The barrier rib 400 may extend in a vertical direction to a surface of the first substrate 100 or the second substrate 200 and be connected between the first and second substrates 100 and 200. A space in which the electrolyte may be filled may be defined by the first and second substrates 100 and 200, and the barrier ribs 400. The barrier ribs 400 may include polymer.

As described above, since the dye-sensitized solar cells including the electrolyte 300 according to embodiments of the present invention does not include iodide having high corrosiveness but include the quaternary ammonium salt compound and the metal anion compound, the electrolytes may improve the stability of the solar cells.

Also, it is possible to adjust the open voltage of dye-sensitized solar cells through multi-redox systems including (X⁻, Y⁻)/(X₃⁻, X₂Y⁻, Y⁻₂X⁻, Y⁻₃).

Hereinafter, operations of the above-described dye-sensitized solar cell will be described briefly.

When sunlight passing through the first substrate 100 is absorbed by the dye 104 molecules adsorbed to the nanoparticle metal oxide 102 of the first electrode 110, the dye 104 molecules may be excited to the excited state to inject electrons into a conduction band of the nanoparticle metal oxide. The electrons injected into the nanoparticle metal oxide 102 may be transferred to the first substrate 100 via interfaces between particles and move to the second electrode 210 via an external wiring. The dye 104 molecules oxidized by the transition of electrons receive electrons supplied from the electrolyte 300 and are reduced, and the oxidized ions (X, Y) are again reduced by the second electrode 210, thereby completing the operations of the solar cell.

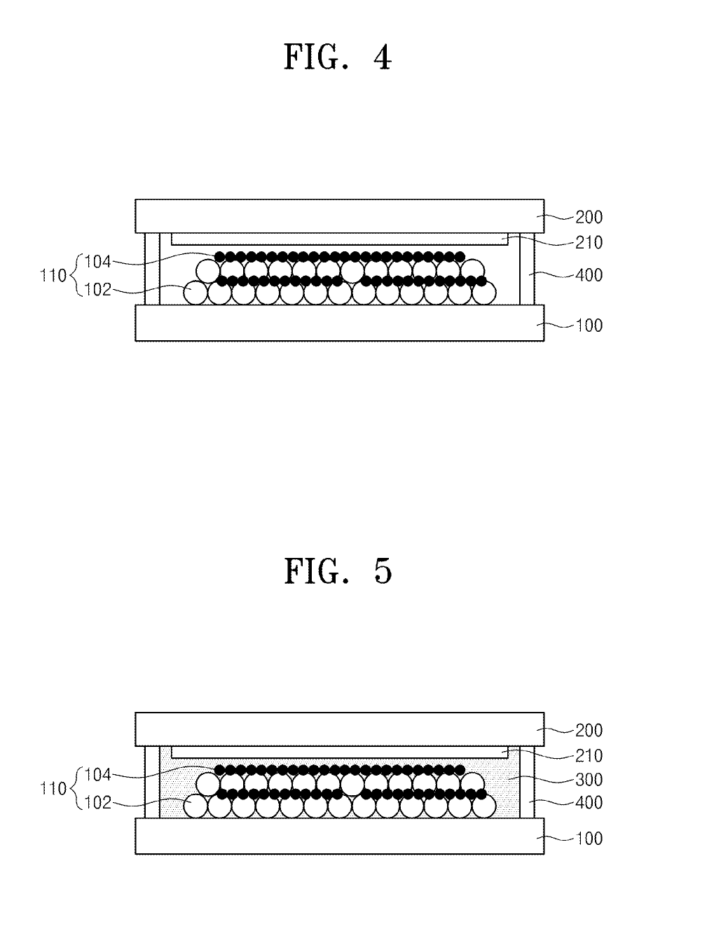

FIGS. 2 through 5 are cross-sectional views for explaining a method of fabricating a dye-sensitized solar cell according to an embodiment of the present invention.

Referring to FIG. 2, a first electrode 110 including a nanoparticle metal oxide 102 to which a dye 104 is adsorbed may be formed on a first substrate 100 coated with ITO or FTO.

In more detail, a printing paste including the nanoparticle metal oxide 102 may be coated at a thickness of about 5 μm to about 30 μm on the first substrate 100 coated with ITO or FTO. Next, the first substrate 100 coated with the printing paste may be thermally treated at a temperature of about 450° C. to about 550° C. to form a nanoparticle metal oxide 102 thin film. Thereafter, the first substrate 100 on which the nanoparticle metal oxide 102 thin film is formed may be dipped in a solution including the dye 104 to form a first electrode 110 to which the dye 104 is adsorbed.

Referring to FIG. 3, a second electrode 210 including platinum may be formed on a second substrate 200 coated with ITO or FTO.

In more detail, a solution including platinum ions is spin-coated on the second substrate 200 coated with ITO or FTO and the second substrate 200 may be thermally treated to form a second electrode 210.

Referring to FIG. 4, after the first and second substrates 100 and 200 are disposed such that the first and second electrodes 110 and 210 face each other, barrier ribs 400 may be formed between the first and second substrates 100 and 200.

Referring to FIG. 5, an electrolyte 300 may be injected into a space defined by the first and second substrates 100 and 200 and the barrier ribs 400.

The electrolyte 300 may include an organic solvent, a metal anion compound (M(Y⁻)ₙ), and a quaternary ammonium salt compound (R₄N⁺X⁻). Since the electrolyte 300 is the same as that described previously, its detailed description will be omitted.

As described above, since the dye-sensitized solar cells including the electrolyte 300 according to embodiments of the present invention does not include iodide having high corrosiveness but include the quaternary ammonium salt compound and the metal anion compound, the electrolytes may improve the stability of the solar cells.

Also, it is possible to adjust the open voltage of dye-sensitized solar cells through multi-redox systems including (X⁻, Y⁻)/(X₃⁻, X₂Y⁻, Y⁻₂X⁻, Y⁻₃).

### Experimental Example

Hereinafter, photoelectric conversion efficiencies of dye-sensitized solar cells fabricated according to the embodiments of the present invention and a dye-sensitized solar cell fabricated according to a typical method will be described.

### Example 1

A printing paste including titanium dioxide (TiO₂) was coated at a thickness of about 5 μm to about 30 μm on a transparent conductive substrate formed of fluorine-tin dioxide (FTO) by a doctor blade method. The printing paste including titanium dioxide was thermally treated at about 450° C. to about 550° C. for about 30 minutes to form a titanium dioxide (TiO₂) thin film at a thickness of about 5 μm to about 30 μm. Thereafter, the titanium dioxide thin film was dipped in a solution including a JJ-7 Ruthenium-based dye for 18 hours to adsorb the dye, thus fabricating a photoelectrode. Also, an isopropylalcohol solution including about 10 mM of platinum ions was spin-coated on a transparent conductive glass substrate at a speed of about 1,000 RPM, and then the resultant transparent conductive glass substrate was thermally treated at a temperature of about 450° C. to about 550° C. for about 30 minutes to fabricate a counter electrode. The photoelectrode fabricated as above was coupled to the counter electrode having a hole for injecting an electrolyte by using a surlyn film. Thereafter, an electrolyte, which was prepared by mixing 0.05 M of lead tetraacetate, 0.6 M of hexyl dimethylimidazolium iodide, 0.5 M of t-butylpyridine, and 0.1 M of guanidine thiocyanate with acetonitrile valeronitrile (85:15) that is an organic solvent, was injected into the hole of the counter electrode to fabricate a dye-sensitized solar cell.

### Example 2

Example 2 was conducted by the same method as that in Example 1 except that the concentration of hexyl dimethylimidazolium iodide used in the fabrication of an electrolyte was 0.05 M.

### Example 3

Example 3 was conducted by the same method as that in Example 1 except that the concentration of hexyl dimethylimidazolium iodide used in the fabrication of an electrolyte was 0.1 M.

### Example 4

Example 4 was conducted by the same method as that in Example 1 except that the concentration of hexyl dimethylimidazolium iodide used in the fabrication of an electrolyte was 0.2 M.

### Example 5

Example 5 was conducted by the same method as that in Example 1 except that the concentration of hexyl dimethylimidazolium iodide used in the fabrication of an electrolyte was 0.4 M.

### Example 6

Example 6 was conducted by the same method as that in Example 1 except that the concentration of hexyl dimethylimidazolium iodide used in the fabrication of an electrolyte was 0.8 M.

### Example 7

Example 7 was conducted by the same method as that in Example 1 except that dimethylammoniumformamide was used as an organic solvent in the fabrication of an electrolyte.

### Example 8

Example 8 was conducted by the same method as that in Example 1 except that 3-methoxypropionitrile was used as an organic solvent in the fabrication of an electrolyte.

### Example 9

Example 9 was conducted by the same method as that in Example 1 except that ethanol was used as an organic solvent in the fabrication of an electrolyte.

### Example 10

Example 10 was conducted by the same method as that in Example 1 except that ethyl trimethylindolinium iodide was used as a quaternary ammonium salt in the fabrication of an electrolyte.

### Example 11

Example 11 was conducted by the same method as that in Example 1 except that tetrabutylammonium iodide was used as a quaternary ammonium salt in the fabrication of an electrolyte.

### Comparative Example

A dye-sensitized solar cell was fabricated by the same method as that in Example 1 except that a Merck's electrolyte which was prepared by mixing 1.0 M of dimethylimidazolium iodide, 0.05 M of lithium iodide, 0.03 M of iodine, 0.5 M of t-butylpyridine, and 0.1 M of guanidine thiocyanate with acetonitrile valeronitrile (85:15) that is an organic solvent.

Components of the electrolytes used in Examples 1 to 11 and Comparative Example are listed on Table 1 below.

TABLE 1

| | | Quaternary | Lead | | |
|---|---|---|---|---|---|
| | | ammonium | tetraacetate | | |
| | Organic | salt | (Metal anion | t- | Guanidine |
| | Solvent | compound | compound) | butylpyridine | thiocyanate |
| Example 1 | Acetonitrile: | 0.6M of | 0.05M | 0.05M | 0.1< |
| | Valeronitrile | hexyl | | | |
| | (85:15) | dimethylimidazolium | | | |
| | | iodide | | | |
| Example 2 | Acetonitrile: | 0.05M of | 0.05M | 0.5M | 0.1< |
| | Valeronitrile | hexyl | | | |
| | (85:15) | dimethylimidazolium | | | |
| | | iodide | | | |
| Example 3 | Acetonitrile: | 0.1M of | 0.05M | 0.5M | 0.1< |
| | Valeronitrile | hexyl | | | |
| | (85:15) | dimethylimidazolium | | | |
| | | iodide | | | |
| Example 4 | Acetonitrile: | 0.2M of | 0.05M | 0.5M | 0.1< |
| | Valeronitrile | hexyl | | | |
| | (85:15) | dimethylimidazolium | | | |
| | | iodide | | | |
| Example 5 | Acetonitrile: | 0.4M of | 0.05M | 0.5M | 0.1< |
| | Valeronitrile | hexyl | | | |
| | (85:15) | dimethylimidazolium | | | |
| | | iodide | | | |
| Example 6 | Acetonitrile: | 0.8M of | 0.05M | 0.5M | 0.1< |
| | Valeronitrile | hexyl | | | |
| | (85:15) | dimethylimidazolium | | | |
| | | iodide | | | |
| Example 7 | Dimethylammoni- | 0.6M of | 0.05M | 0.5M | 0.1< |
| | umformamide | hexyl | | | |
| | | dimethylimidazolium | | | |
| | | iodide | | | |
| Example 8 | 3-methoxypro- | 0.6M of | 0.05M | 0.5M | 0.1< |
| | pionenitrile | hexyl | | | |
| | | dimethylimidazolium | | | |
| | | iodide | | | |
| Example 9 | Ethanol | 0.6M of | 0.05M | 0.5M | 0.1< |
| | | hexyl | | | |
| | | dimethylimidazolium | | | |
| | | iodide | | | |
| Example 10 | Acetonitrile: | Ethyl | 0.05M | 0.5M | 0.1< |
| | Valeronitrile | trimethylindolinium | | | |
| | (85:15) | iodide | | | |
| Example 11 | Acetonitrile: | 0.6M of | 0.05M | 0.5M | 0.1< |
| | Valeronitrile | tetrabutylammonium | | | |
| | (85:15) | iodide | | | |

| | | | | |
|---|---|---|---|---|
| Comparative | Acetonitrile: | 1.0M of dimethylimidazolium iodide | 0.5M | 0.1< |
| Example | Valeronitrile | 0.05M of lithium iodide | | |
| | (85:15) | 0.03M of iodine | | |

To evaluate the photoelectric conversion efficiencies of the dye-sensitized solar cells fabricated in Examples 1 to 11 and Comparative Example, a 300 W Xenon lamp (made by Oriel) was used as a light source, and the sunlight condition (AM 1.5) of the Xenon lamp was calibrated by using a standard solar cell. The photovoltage and photocurrent were measured by the above method to observe photoelectric characteristics of the dye-sensitized solar cells, and the photoelectric conversion efficiency (ηₑ) was calculated using current density (I_{sc}), voltage (V_{oc}), and fill factor (FF) obtained thus by Equation 1 and results are shown in Table 2.

ηₑ=(V_{oc}×J_{sc}×FF)/(Pᵢₙₑ) [Equation 1]

where (Pᵢₙₑ) indicates 100 mW/cm² (1 sun).

The values measured according to Equation 1 are shown in Table 2.

TABLE 2

| | | | | Photoelectric |
|---|---|---|---|---|
| | | | Fill | conversion |
| Item | V_{oc} (mV) | J_{sc} (mA/cm²) | factor (FF) | efficiency (%) |
| Example 1 | 833 | 9.42 | 66.2 | 5.23 |
| Example 2 | 738 | 7.47 | 46.1 | 2.54 |
| Example 3 | 777 | 6.61 | 62.2 | 3.20 |
| Example 4 | 812 | 10.04 | 63.5 | 5.18 |
| Example 5 | 820 | 9.94 | 65.9 | 5.37 |
| Example 6 | 835 | 9.48 | 66.9 | 5.30 |
| Example 7 | 870 | 5.58 | 65.1 | 3.16 |
| Example 8 | 818 | 9.01 | 49.4 | 3.64 |
| Example 9 | 731 | 5.45 | 72.4 | 2.88 |
| Example 10 | 664 | 0.80 | 23.1 | 0.12 |
| Example 11 | 860 | 9.78 | 46.5 | 3.91 |
| Comparative | 761 | 11.20 | 62.0 | 5.29 |
| Example | | | | |

As shown in Table 2, it can be seen that the photoelectric conversion efficiencies of Examples 1 and 4 through 6 in which electrolytes to which iodine was not added were used are similar to that of Comparative Example in which the Merck's electrolyte to which iodine was added was used.

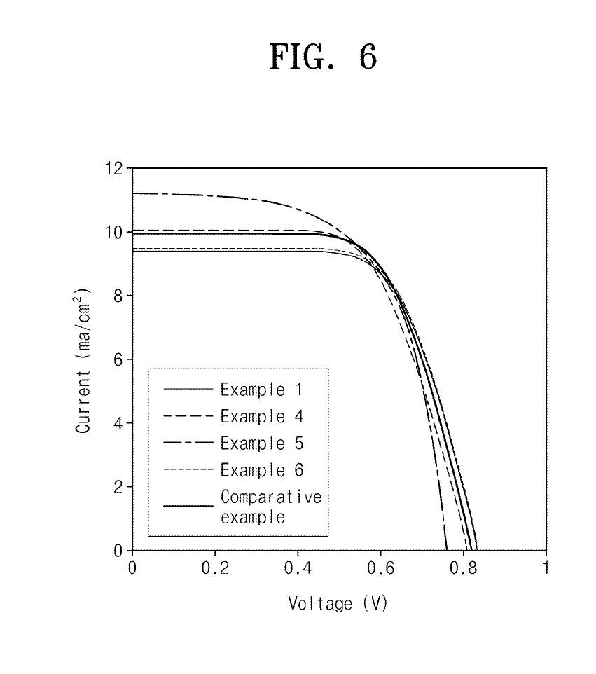

FIG. 6 is a current-voltage graph showing measurement results of photovoltage and photocurrent in dye-sensitized solar cells fabricated according to Examples 1, and 4 through 6, and Comparative Example.

Referring to FIG. 6, it can be seen that the photocurrents in Examples 1, 4 to 6 are somewhat lower than that in Comparative Example but the photocurrents in Examples 1, 4 through 6 are higher than that in Comparative Example.

As described above, by the embodiments according to the inventive concepts, it is possible to adjust an open voltage of a dye-sensitized solar cell through multi-redox systems including (X⁻, Y⁻)/(X₃⁻, X₂Y⁻, Y⁻₂X⁻, Y⁻₃). The open-circuit voltage may be increased to enhance the overall efficiency of the solar cell. Also, since the solar cells include an electrolyte from which iodide (I₂) causing corrosion of the solar cells is removed, the stability of the solar cells may be enhanced.

Although exemplary embodiments of the present invention are described above with reference to the accompanying drawings, those skilled in the art will understand that the present invention may be implemented in various ways without changing the necessary features or the spirit of the present disclosure. Thus, the above embodiments should be construed to be exemplary rather than as limitative.

What is claimed is:

1. An electrolyte for a dye-sensitized solar cell comprising:
an organic solvent;
a metal anion compound (M(Y⁻)ₙ), and
a quaternary ammonium salt compound (R₄N⁺X⁻), where X⁻ and Y⁻ are multi-redox systems which are in chemical equilibrium.

2. The electrolyte of claim 1, wherein the multi-redox systems comprise (X⁻, Y⁻)/(X₃⁻, X₂Y⁻, Y⁻₂X⁻, Y⁻₃).

3. The electrolyte of claim 1, wherein X⁻ comprises a halogen anion, an alkyl anion, an alkyloxy anion, an acetoxy anion or an alkylthiol anion, and Y⁻ comprises an alkyl anion, an alkyloxy anion, an acetoxy anion, a phenyl anion, a phenyloxy anion, or an alkylthiol anion.

4. The electrolyte of claim 1, wherein M comprises Pb, Pd, Zn, Sn, Co, Li or Cu.

5. The electrolyte of claim 1, wherein the quaternary ammonium salt compound comprises at least one selected from the group consisting of hexyldimethylimidazolium iodide (HDMII), ethyltrimethylindolium iodide (ETMII), and tetrabutylammonium iodide (Bu₄N⁺I⁻).

6. The electrolyte of claim 1, wherein the organic solvent comprises at least one selected from the group consisting of acetonitrile, valeronitrile, alcohols, such as methanol, ethanol, propanol and butanol, ethyl ether, acetone, dimethylcarbonate, 3-methoxypropionitrile, tetrahydrofuran, dichloromethane, dichloroethane, and chloroform.

7. The electrolyte of claim 1, further comprising an additive, wherein the additive comprises guanidine thiocyanate and t-butylpyridine.

8. The electrolyte of claim 7, wherein the metal anion compound (M(Y⁻)ₙ) is 0.05 M based on the organic solvent,
the quaternary ammonium salt compound (R₄N⁺X⁻) is 0.05 M to 0.6 M based on the organic solvent,
the t-butylpyridine is 0.5 M based on the organic solvent, and
the guanidine thiocyanate is 0.1 M based on the organic solvent.

9. A dye-sensitized solar cell comprising:
a first electrode formed on a first substrate;
a second electrode formed on a second substrate and facing the first electrode; and
an electrolyte filled between the first and second electrodes and including an organic solvent, a metal anion compound (M(Y⁻)ₙ), and a quaternary ammonium salt compound (R₄N⁺X⁻), where X⁻ and Y⁻ are multi-redox systems which are in chemical equilibrium.

10. The dye-sensitized solar cell of claim 9, wherein the first electrode comprises a nanoparticle metal oxide layer which is formed on the first substrate facing the second electrode and to which a dye is adsorbed.

11. The dye-sensitized solar cell of claim 9, wherein the second electrode comprises a platinum layer formed on the second substrate facing the first electrode.

12. The dye-sensitized solar cell of claim 9, wherein X⁻ comprises a halogen anion, an alkyl anion, an alkyloxy anion, an acetoxy anion or an alkylthiol anion, Y⁻ comprises an alkyl anion, an alkyloxy anion, an acetoxy anion, a phenyl anion, a phenyloxy anion, or an alkylthiol anion, and M comprises Pb, Pd, Zn, Sn, Co, Li or Cu.
